(19) United States
(12) Patent Application Publication
(10) Pub. No.: US 2026/0349569 A1
(43) Pub. Date: Nov. 5, 2026

(54) ELECTRONIC DEVICE INCLUDING SENSOR LAYER

(71) Applicant: SAMSUNG DISPLAY CO., LTD., YONGIN-SI (KR)

(72) Inventors: DAE WON KIM, Yongin-si (KR); KIHO LIM, Yongin-si (KR)

(21) Appl. No.: 19/540,158

(22) Filed: Feb. 13, 2026

(30) Foreign Application Priority Data
May 2, 2025 (KR) 10-2025-0058360

(51) Int. Cl. G06F 3/044; G06F 3/041

(52) U.S. Cl. CPC G06F 3/0446; G06F 3/0416; G06F 3/0443; G06F 3/0448; G06F 2203/04111

(57) ABSTRACT

An electronic device includes a sensor layer having a first region and a second region. The sensor layer includes a first electrode disposed in the first region, a second electrode disposed in the second region, and a third electrode disposed in the first region and the second region. The third electrode includes a plurality of sensing patterns and a plurality of bridge patterns, each of the plurality of bridge patterns electrically connecting adjacent sensing patterns to each other, and an area of the first region is defined to be equal to an area of the second region. A number of a plurality of first bridge patterns among the plurality of bridge patterns overlapping the first region is greater than a number of a plurality of second bridge patterns among the plurality of bridge patterns overlapping the second region.

### CROSS-REFERENCE TO RELATED APPLICATIONS

This application claims priority under 35 U.S.C. § 119 to Korean Patent Application No. 10-2025-0058360, filed on May. 02, 2025, in the Korean Intellectual Property Office, the disclosure of which is incorporated by reference herein in its entirety.

### TECHNICAL FIELD

The present disclosure relates to an electronic device. More specifically, the present disclosure relates to an electronic device including a sensor layer.

### DISCUSSION OF THE RELATED ART

The present disclosure herein relates to an electronic device including a sensor layer having improved sensitivity and enhanced reliability.

Multimedia electronic devices such as a television, a mobile phone, a tablet computer, a navigation system, and a game console are equipped with a display device for displaying images. In addition to typical input methods such as a button, a keyboard, and a mouse, the display device may provide a touch-based input method that allows a user to input information or commands easily, intuitively, and conveniently.

### SUMMARY

The present disclosure provides an electronic device including a sensor layer having improved sensitivity and enhanced reliability.

In an embodiment of the present disclosure, an electronic device includes a sensor layer having a first region and a second region, the second region being adjacent to the first region. The second region is configured to be folded and unfolded. The sensor layer includes a first electrode disposed in the first region and extending along a first direction, a second electrode disposed in the second region, extending along the first direction, and spaced apart from the first electrode in a second direction, the second direction intersects the first direction, and a third electrode disposed in the first region and the second region, extending along the second direction, and intersecting the first electrode and the second electrode. The third electrode includes a plurality of sensing patterns and a plurality of bridge patterns, each of the plurality of bridge patterns electrically connecting adjacent sensing patterns among the plurality of sensing patterns to each other, and an area of the first region is defined to be equal to an area of the second region. A number of a plurality of first bridge patterns among the plurality of bridge patterns overlapping the first region is greater than a number of a plurality of second bridge patterns among the plurality of bridge patterns overlapping the second region.

In several embodiments, the number of the plurality of first bridge patterns may be more than or equal to about 1.5 times the number of the plurality of second bridge patterns.

In several embodiments, the first electrode and the second electrode may be provided as a plurality of first electrodes and second electrodes, and a number of the plurality of first electrodes disposed in the first region may be greater than a number of the plurality of second electrodes disposed in the second region.

In several embodiments, the first electrode may be provided as a plurality of first electrodes, the plurality of first electrodes may be disposed in the first region, and a single second electrode may be disposed in the second region.

In several embodiments, a number of the plurality of first bridge patterns overlapping the first electrode may be equal to a number of the plurality of second bridge patterns overlapping the second electrode.

In several embodiments, a width of the first electrode in the second direction may be smaller than a width of the second electrode in the second direction.

In several embodiments, the width of the first electrode in the second direction may be less than or equal to about two-thirds of the width of the second electrode in the second direction.

In several embodiments, a maximum width in the second direction of each of the plurality of sensing patterns of the third electrode in the first region may be smaller than a maximum width in the second direction of each of the plurality of sensing patterns of the third electrode in the second region.

In several embodiments, a number of the plurality of first bridge patterns overlapping the first electrode may be greater than a number of the plurality of second bridge patterns overlapping the second electrode.

In several embodiments, the number of the plurality of first bridge patterns overlapping the first electrode may be greater than or equal to about 2 times the number of the plurality of second bridge patterns overlapping the second electrode.

In several embodiments, a width of the first electrode in the second direction may be the same as a width of the second electrode in the second direction.

In several embodiments, the electronic device may include a sensor driver configured to drive the sensor layer, the first electrode may be configured to receive a first driving signal from the sensor driver, and the second electrode may be configured to receive a second driving signal different from the first driving signal from the sensor driver. A period of the first driving signal may be longer than a period of the second driving signal.

In several embodiments, the sensor layer may include a first trace line electrically connected to the first electrode, and a second trace line electrically connected to the second electrode. A width of the first trace line may be smaller than a width of the second trace line.

In several embodiments, the plurality of bridge patterns may be disposed in a layer different from a layer in which the plurality of sensing patterns are disposed.

In several embodiments of the present disclosure, an electronic device includes a display layer, a sensor layer disposed on the display layer and having a first region and a second region, the second region being adjacent to the first region and configured to be folded and unfolded, and a processor configured to control the display layer and the sensor layer. The sensor layer includes a plurality of first electrodes disposed in the first region, extending along a first direction, and arranged in a second direction, the second direction intersects the first direction, a second electrode disposed in the second region and extending along the first direction, and a plurality of third electrodes disposed in the first region and the second region, extending along the second direction, and arranged in the first direction. Each of the plurality of third electrodes includes a plurality of sensing patterns and a plurality of bridge patterns, each of the plurality of bridge patterns electrically connecting adjacent sensing patterns among the plurality of sensing patterns to each other, the plurality of bridge patterns including a plurality of first bridge patterns and a plurality of second bridge patterns, and an area of the first region is defined to be equal to an area of the second region. A number of the plurality of first bridge patterns overlapping the first region is greater than a number of the plurality of second bridge patterns overlapping the second region.

In several embodiments, the second electrode may be provided as a plurality of second electrodes, and a number of the plurality of first electrodes disposed in the first region may be greater than a number of the plurality of second electrodes disposed in the second region.

In several embodiments, a number of the plurality of first bridge patterns overlapping a single first electrode among the plurality of first electrodes may be equal to a number of the plurality of second bridge patterns overlapping the second electrode. A width of the single first electrode in the second direction may be smaller than a width of the second electrode in the second direction.

In several embodiments, a number of the plurality of first bridge patterns overlapping a single first electrode among the plurality of first electrodes may be greater than a number of the plurality of second bridge patterns overlapping the second electrode. A width of the single first electrode in the second direction may be equal to a width of the second electrode in the second direction.

In several embodiments, a sensor driver may be configured to drive the sensor layer. Each of the plurality of first electrodes may be configured to receive a first driving signal from the sensor driver, and the second electrode may be configured to receive a second driving signal different from the first driving signal from the sensor driver. A period of the first driving signal may be longer than a period of the second driving signal.

In several embodiments of the present disclosure, display device includes a display panel including a display layer, and a sensor layer having a first region and a second region, the second region being adjacent to the first region, wherein the second region is configured to be folded and unfolded. The sensor layer includes a first electrode disposed in the first region and extending along a first direction, a second electrode disposed in the second region, extending along the first direction, and spaced apart from the first electrode in a second direction, the second direction intersects the first direction, and a third electrode disposed in the first region and the second region, extending along the second direction, and intersecting the first electrode and the second electrode. The third electrode includes a plurality of sensing patterns and a plurality of bridge patterns, each of the plurality of bridge patterns electrically connecting adjacent sensing patterns among the plurality of sensing patterns to each other, and an area of the first region is defined to be equal to an area of the second region. A number of a plurality of first bridge patterns among the plurality of bridge patterns overlapping the first region is greater than a number of a plurality of second bridge patterns among the plurality of bridge patterns overlapping the second region.

### BRIEF DESCRIPTION OF THE FIGURES

The above and other features of the disclosure will become more apparent from the following description of the embodiments, taken in conjunction with the accompanying drawings, in which:

FIG. 1 is a block diagram of an electronic device, according to an embodiment;

FIG. 2A is a perspective view of the electronic device, according to an embodiment;

FIG. 2B illustrates a folded state of the electronic device illustrated in FIG. 2A, according to an embodiment;

FIG. 3A is a perspective view of an electronic device, according to an embodiment;

FIG. 3B is a rear perspective view of the electronic device, according to an embodiment;

FIG. 4 is a cross-sectional view of a display panel, according to an embodiment;

FIG. 5 is a block diagram illustrating a use of the electronic device, according to an embodiment;

FIG. 6A is a cross-sectional view of the display panel, according to an embodiment;

FIG. 6B is a cross-sectional view illustrating a partial configuration of a sensor layer, according to an embodiment;

FIG. 7 is a plan view of a display layer, according to an embodiment;

FIG. 8 is a plan view of a sensor layer, according to an embodiment;

FIG. 9 is an enlarged view of region AA' of FIG. 8, according to an embodiment;

FIG. 10 is an enlarged view of region AA' of FIG. 8, according to an embodiment;

FIG. 11 is a plan view of a sensor layer, according to an embodiment;

FIG. 12 is an enlarged view of region AA' of FIG. 11, according to an embodiment;

FIG. 13A illustrates a waveform of a first driving signal, according to an embodiment;

FIG. 13B illustrates a waveform of a second driving signal, according to an embodiment; and

FIG. 14 is a plan view of a sensor layer, according to an embodiment.

### DETAILED DESCRIPTION

The present invention will now be described more fully hereinafter with reference to the accompanying drawings, in which embodiments of the invention are shown. In the following description, portions necessary for understanding an operation according to the disclosure may be described, and descriptions of other portions may be omitted. In addition, the disclosure may be embodied in other forms without being necessarily limited to the embodiments described herein. The embodiments described herein are provided so that this disclosure will be thorough and complete, and will fully convey the scope of the invention to those skilled in the art.

Spatially relative terms such as “at the bottom”, “lower”, “below”, “above”, “on top”, “on the top”, “on”, etc., are used to explain a relationship between components shown in the drawings. The terms are relative concepts and are explained based on the direction indicated in the drawings. Spatially relative terms are intended to include other directions in use, in operation, and/or in manufacturing, in addition to the direction depicted in the drawings. For example, in case that a device shown in the drawing is turned upside down, elements depicted as being positioned “under” other elements or features are positioned in a direction “on” the other elements or features. Therefore, in an embodiment, the term “under” may include both directions of “on” and “under”.

Embodiments of the present disclosure are described with the understanding that when an element is referred to as being “connected” or “coupled” to another element, it may be directly connected or coupled to the other element or intervening element(s) may be present. In contrast, when an element is referred to as being “directly connected” or “directly coupled” to another element, there might be no intervening elements present. Other words used to describe the relationship between elements should be interpreted in a like fashion (e.g., “between” versus “directly between,” “adjacent” versus “directly adjacent,” etc.).

Same reference numerals are used for the same components in the drawings, and redundant descriptions of the same components may be omitted. To the extent that an element is not described in detail with respect to a figure, it may be understood that the element is at least similar to a corresponding element that has been described elsewhere within the present disclosure.

While each drawing may represent one or more particular embodiments of the present disclosure, drawn to scale, such that the relative lengths, thicknesses, and angles can be inferred therefrom, it is to be understood that the present invention is not necessarily limited to the relative lengths, thicknesses, and angles shown. Changes to these values may be made within the spirit and scope of the present disclosure, for example, to allow for manufacturing limitations and the like.

Although the terms “first”, "second", etc. may be used herein to describe various elements, these elements, should not necessarily be limited by these terms. These terms may be used to distinguish one element from another element. Thus, a first element discussed below may be termed a second element without departing from the teachings of one or more embodiments. The description of an element as a “first” element may not require or imply the presence of a second element or other elements. The terms “first”, “second”, etc., may also be used herein to differentiate different categories or sets of elements. For conciseness, the terms “first”, “second”, etc., may represent “first-category (or first-set)”, “second-category (or second-set)”, etc., respectively.

Embodiments of the disclosure are described with the understanding that the terms "include" and/or "have", when used in this specification, may specify the presence of stated features, integers, steps, operations, elements, components and/or groups thereof, but do not necessarily preclude the presence or addition of one or more other features, integers, steps, operations, elements, components, and/or groups thereof.

Hereinafter, embodiments of the inventive concept will be described with reference to the accompanying drawings.

Traditionally, an electronic device may include a sensor layer. The sensor layer may be configured to detect a touch input and may be electrically connected to a control circuit. However, the sensitivity of the sensor layer may be reduced over time, for example, because of the folding of the electronic device.

To resolve these challenges, an arrangement of the sensor layer is disclosed. The sensor layer may be divided into a first region and a second region. A first electrode may be disposed in the first region, and a second electrode may be disposed in the second region. A third electrode may be disposed in the first and the second region. For example, a third electrode may be disposed to cross a first electrode and the second electrode. Additionally, a third electrode may include a plurality of first bridge patterns and a plurality of second bridge patterns. For example, a number of a plurality of first bridge patterns overlapping the first region may be greater than a number of a plurality of second bridge patterns overlapping the second region. In several embodiments, the disclosed arrangement of the sensor layer ensures improved sensitivity and durability, despite folding and unfolding of the electronic device. For example, the disclosed arrangement of the sensor layer ensures that a contact between the plurality of second bridge patterns and the layers disposed above and below may be reduced when the electronic device is folded and unfolded.

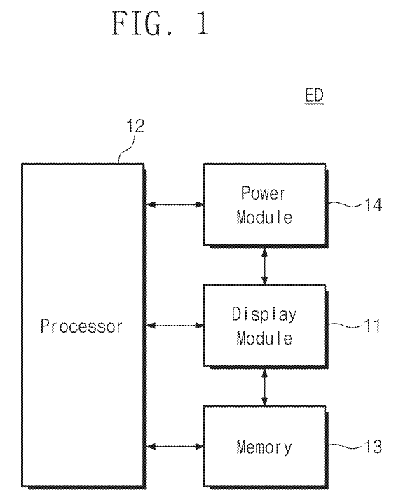

FIG. 1 is a block diagram of an electronic device ED according to an embodiment of the present disclosure.

Referring to FIG. 1, the electronic device ED according to an embodiment of the inventive concept may include a display module 11, a processor 12, a memory 13, and a power module 14.

The display module 11 may display an image. The image may include a dynamic image as well as a still image. The processor 12 may include at least one of a central processing unit (CPU), an application processor (AP), a graphic processing unit (GPU), a communication processor (CP), an image signal processor (ISP), or a controller. The processor 12 may be configured to control the operation of the display module 11.

The memory 13 may store data information necessary for the operation of the processor 12 or the display module 11. When the processor 12 executes an application stored in the memory 13, an image data signal and/or an input control signal is transmitted to the display module 11, and the display module 11 may process the received signal and output image information through a display screen.

The power module 14 may include a power supply module, such as a power adapter or a battery device, and a power conversion module that converts power supplied by the power supply module and generates power necessary for the operation of the electronic device ED.

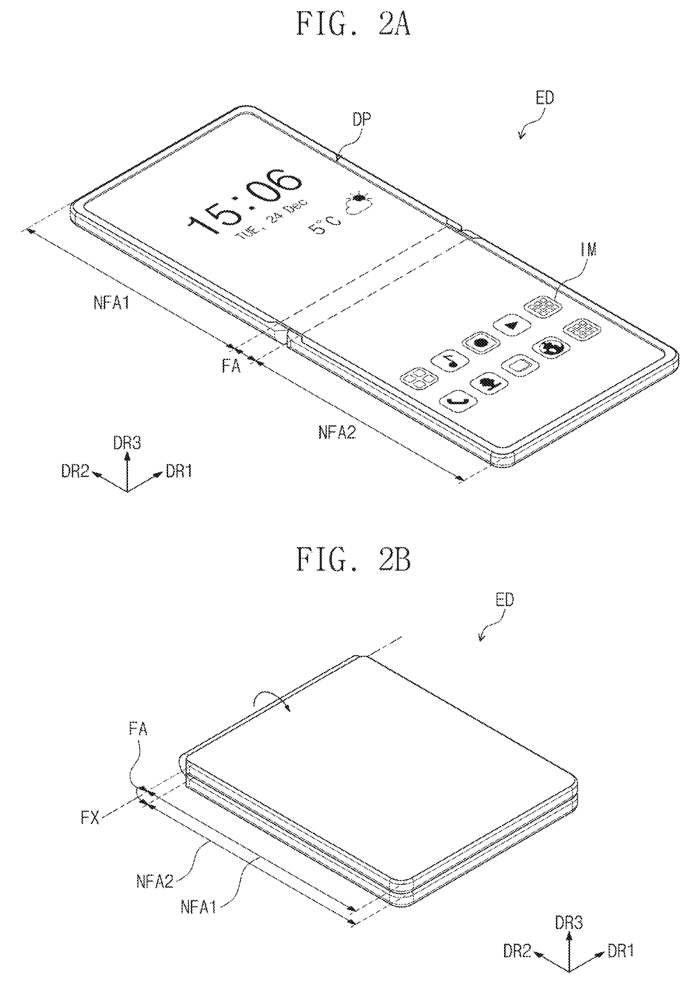

FIG. 2A is a perspective view of the electronic device ED according to an embodiment of the present disclosure. FIG. 2B illustrates a folded state of the electronic device ED illustrated in FIG. 2A according to an embodiment of the present disclosure.

Referring to FIGS. 2A and 2B, the electronic device ED may have a rectangular shape with short sides extending in a first direction DR1 and comparatively longer sides extending in a second direction DR2. However, an embodiment of the inventive concept is not necessarily limited thereto, and the electronic device ED may have various shapes such as a circle or a polygon. In several embodiments, the electronic device ED may be a flexible electronic device.

The electronic device ED may include a folding region FA and a plurality of non-folding regions NFA1 and NFA2. For example, the electronic device ED may include a first non-folding region NFA1 and a second non-folding region NFA2. The folding region FA may be disposed between the first non-folding region NFA1 and the second non-folding region NFA2. The first non-folding region NFA1, the folding region FA, and the second non-folding region NFA2 may be arranged in a direction parallel to the second direction DR2.

For example, one folding region FA and two non-folding regions NFA1 and NFA2 are illustrated in FIGS. 2A and 2B, but the number of the folding regions FA and the non-folding regions NFA1 and NFA2 is not necessarily limited thereto. For example, the electronic device ED may include a plurality of non-folding regions and a plurality of folding regions disposed between the non-folding regions. For example, a number of non-folding regions may be greater than two.

The electronic device ED may include a display panel DP. Images IM generated by the electronic device ED may be provided to a user through the display panel DP. For example, a user may visualize images IM through the display panel DP.

The display panel DP may include a display region DA and a non-display region surrounding the display region DA. The display region DA may display images, and the non-display region may not display images. In an embodiment, the non-display region may be disposed to surround the display region DA.

In several embodiments, the electronic device ED may be implemented as a display device. For example, the display device may include a display panel DP. Images IM generated by the display device may be provided to a user through the display panel DP.

In several embodiments, the electronic device ED may include a plurality of sensors and at least one camera.

In an embodiment, the electronic device ED may be a foldable electronic device ED that may be folded or unfolded. For example, the electronic device ED may be bent, folded, or rolled to a noticeable extent without cracking or otherwise sustaining damage. For example, the folding region FA may be bent with respect to a folding axis FX parallel to the first direction DR1, so that the electronic device ED may be folded. The folding axis FX may be defined as a short axis parallel to a short side of the electronic device ED.

When the electronic device ED is folded, the first non-folding region NFA1 and the second non-folding regions NFA2 may face each other, and the electronic device ED may be in-folded so that the display region DA is not exposed to the outside. However, the embodiments of the inventive concept are not necessarily limited thereto. For example, the electronic device ED may also be out-folded around the folding axis FX so that the display region DA is exposed to the outside, for example, the display region DA may be exposed to the outside for a user to view.

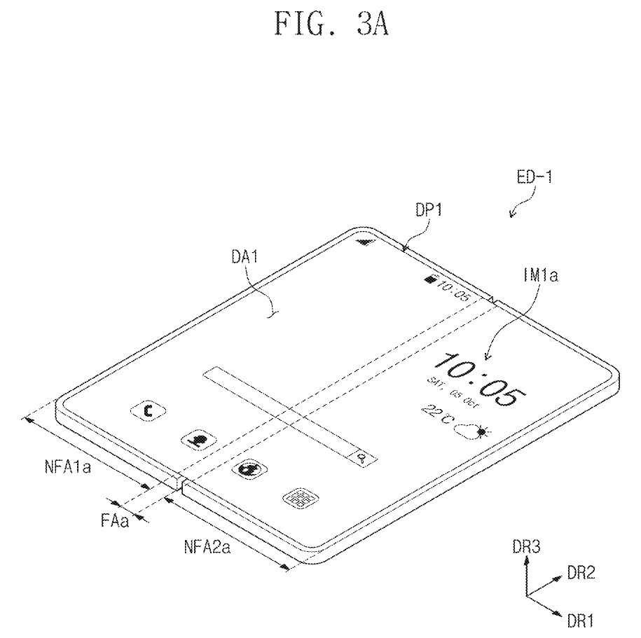

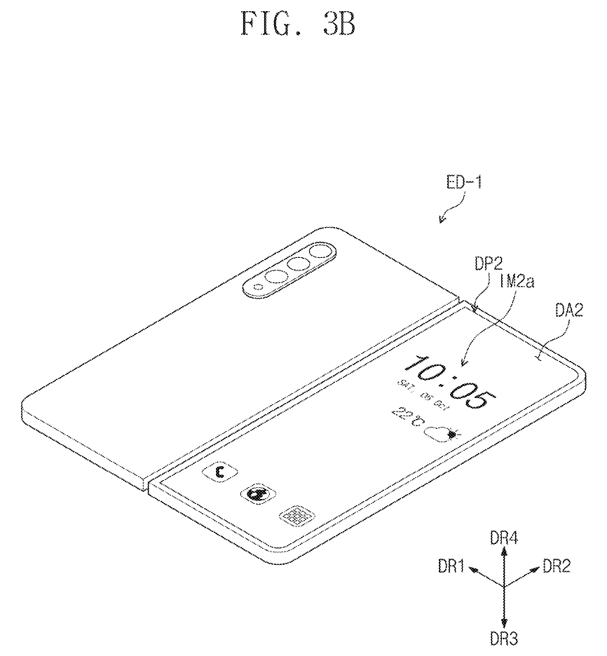

FIG. 3A is a perspective view of an electronic device ED-1 according to an embodiment. FIG. 3B is a rear perspective view of the electronic device ED-1 according to an embodiment of the inventive concept.

Referring to FIGS. 3A and 3B, the electronic device ED-1 may be activated using an electrical signal. For example, the electronic device ED-1 may display images and sense inputs applied from a source external to the electronic device ED-1. An external input may be a user's input. The user's input may include various forms of external inputs, such as a part of the user's body, a pen/stylus, light, heat, or pressure.

The electronic device ED-1 may include a first display panel DP1 and a second display panel DP2. The first display panel DP1 and the second display panel DP2 may be separate panels spaced apart from each other. The first display panel DP1 may be referred to as a main display panel, and the second display panel DP2 may be referred to as an auxiliary display panel or an external display panel.

The first display panel DP1 may include a first display region DA1, and the second display panel DP2 may include a second display region DA2. The area of the second display panel DP2 may be smaller than the area of the first display panel DP1. In several embodiments, depending on the sizes of the first display panel DP1 and the second display panel DP2, the area of the first display region DA1 may be larger than the area of the second display region DA2.

When the electronic device ED-1 is unfolded, the first display region DA1 may have a plane substantially parallel to the first direction DR1 and the second direction DR2. The thickness direction of the electronic device ED-1 may be parallel to a third direction DR3 crossing the first direction DR1 and the second direction DR2. For example, the third direction DR3 may intersect the first direction DR1 and the second direction DR2. Therefore, the front (or upper) and rear (or lower) surfaces of the members constituting the electronic device ED-1 may be defined based on the third direction DR3.

The first display panel DP1 or the first display region DA1 may include a folding region FAa, which may be folded and unfolded, and a plurality of non-folding regions NFA1a and NFA2a spaced apart from each other with the folding region FAa interposed therebetween. The second display panel DP2 may overlap any one of the plurality of non-folding regions NFA1a and NFA2a. For example, the second display panel DP2 may overlap the first non-folding region NFA1a.

The display direction of a first image IM1a that is displayed on the first display panel DP1 and the display direction of a second image IM2a that is displayed on the second display panel DP2 may be opposite to each other. For example, the first image IM1a may be displayed in the third direction DR3, and the second image IM2a may be displayed in a fourth direction DR4 that is opposite to the third direction DR3.

In an embodiment, the folding region FAa may be bent with respect to a folding axis extending along a direction parallel to a long side of the electronic device ED-1, for example, a direction parallel to the second direction DR2. When the electronic device ED-1 is folded, the folding region FAa has a predetermined curvature and a predetermined curvature radius. The first non-folding region NFA1a and the second non-folding region NFA2a may face each other, and the electronic device ED-1 may be in-folded so that the first display region DA1 is not exposed to the outside.

In an embodiment, the electronic device ED-1 may be out-folded so that the first display region DA1 is exposed to the outside. In an embodiment, the electronic device ED-1 may be in-folded or out-folded, but the disclosure is not necessarily limited thereto.

FIG. 3A exemplarily illustrates that one folding region FAa is defined (provided or included) in the electronic device ED-1, but embodiments of the inventive concept are not necessarily limited thereto. For example, a plurality of folding axes and a plurality of folding regions corresponding thereto may be defined in the electronic device ED-1, and the electronic device ED-1 may be in-folded or out-folded in each of the plurality of folding regions.

According to an embodiment, at least one of the first display panel DP1 or the second display panel DP2 may sense an input by a pen/stylus even though the display panel does not include a digitizer. Accordingly, since the digitizer for sensing the pen/stylus is omitted, an increase in the thickness and weight of the electronic device ED-1, as well as a decrease in the flexibility of the electronic device ED-1 due to the inclusion of the digitizer, may be prevented. Therefore, in several embodiments, not only the first display panel DP1 but also the second display panel DP2 may be designed to sense the pen/stylus.

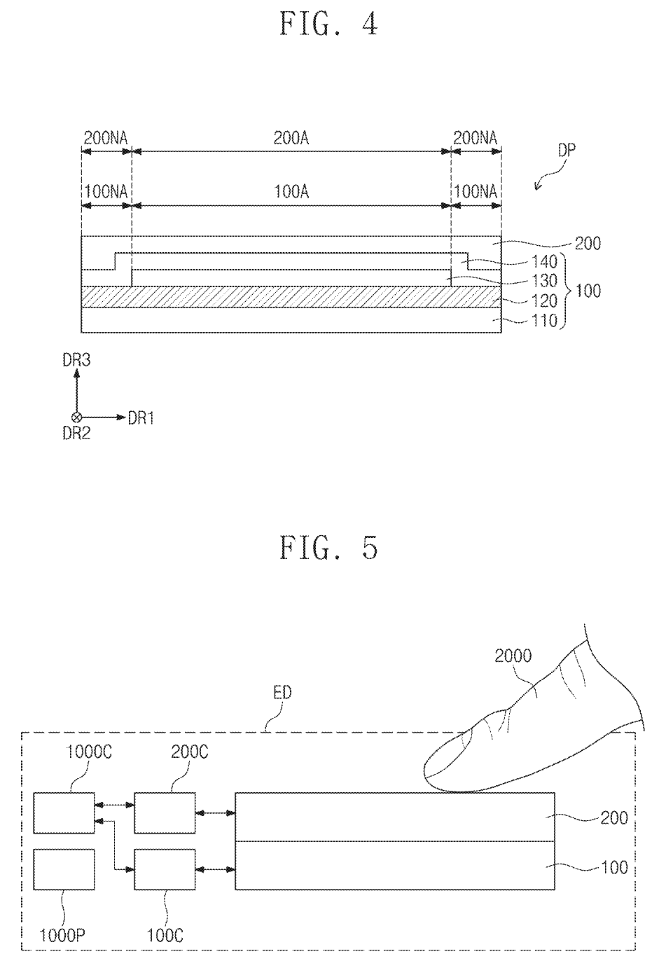

FIG. 4 is a cross-sectional view of the display panel DP according to an embodiment.

Referring to FIG. 4, the display panel DP may include a display layer 100 and a sensor layer 200. An upper functional member may be further disposed on the sensor layer 200. For example, the upper functional member may include at least any one of an anti-reflection layer, a window, or a protective film.

The display layer 100 may be a component that substantially generates an image. A display region 100A and a non-display region 100NA adjacent to the display region 100A may be defined in the display layer 100. An image may be displayed in the display region 100A. The display region 100A of the display layer 100 may correspond to the display region DA of the display panel DP, and the non-display region 100NA of the display layer 100 may correspond to the non-display region of the display panel DP.

The display layer 100 may be a light-emitting display layer, for example, the display layer 100 may be an organic light-emitting display layer, an inorganic light-emitting display layer, an organic-inorganic light-emitting display layer, a quantum dot display layer, a micro LED display layer, or a nano LED display layer. The display layer 100 may include a base layer 110, a circuit layer 120, a light-emitting element layer 130, and an encapsulation layer 140.

The base layer 110 may be a member that provides a base surface on which the circuit layer 120 is disposed. The base layer 110 may have a multi-layer or single-layer structure. The base layer 110 may be a glass substrate, a metal substrate, a silicon substrate, or a polymer substrate, but the disclosure is not necessarily limited thereto.

The circuit layer 120 may be disposed on the base layer 110. The circuit layer 120 may include an insulating layer, a semiconductor pattern, a conductive pattern, a signal line, etc. An insulating layer, a semiconductor layer, and a conductive layer may be formed on the base layer 110 by a method such as coating and deposition, and the insulating layer, the semiconductor layer, and the conductive layer may be selectively patterned through a plurality of photolithography processes.

The light-emitting element layer 130 may be disposed on the circuit layer 120. The light-emitting element layer 130 may include a light-emitting element. For example, the light-emitting element layer 130 may include an organic light-emitting material, an inorganic light-emitting material, an organic-inorganic light-emitting material, a quantum dot, a quantum rod, a micro LED, or a nano LED.

The encapsulation layer 140 may be disposed on the light-emitting element layer 130. The encapsulation layer 140 may protect the light-emitting element layer 130 from moisture, oxygen, and foreign substances such as dust particles.

The sensor layer 200 may be disposed on the display layer 100. A sensing region 200A and a peripheral region 200NA adjacent to the sensing region 200A may be defined in the sensor layer 200. The sensing region 200A may overlap the display region 100A, and the peripheral region 200NA may overlap the non-display region 100NA.

According to an embodiment, the area of the sensing region 200A may be greater than or equal to the area of the display region 100A. FIG. 4 exemplarily illustrates that the area of the sensing region 200A and the area of the display region 100A are the same as each other, but embodiments of the inventive concept are not necessarily limited thereto. For example, a portion of the sensing region 200A may overlap the non-display region 100NA, and the area of the sensing region 200A may be wider than the area of the display region 100A. In several embodiments, even though an input occurs adjacent to the boundary between the display region 100A and the non-display region 100NA, a signal may be sufficiently recognized because the sensing region 200A also overlaps a portion of the non-display region 100NA. Therefore, the coordinate accuracy for a touch input at the outer edge of the display region 100A may be further improved.

The sensor layer 200 may sense an external input applied from the outside, for example, from a source external to the electronic device ED. The sensor layer 200 may be an integrated sensor continuously formed during the manufacturing process of the display layer 100, or the sensor layer 200 may be an external sensor attached to the display layer 100. The sensor layer 200 may be referred to as a sensor, an input sensing layer, an input sensing panel, or an electronic device for sensing input coordinates.

According to an embodiment, the sensor layer 200 may sense both inputs by a passive-type input means such as a user's body and inputs by an input device that generates a magnetic field having a predetermined resonant frequency. The input device may be referred to as a pen/stylus, an input pen, a magnetic pen, a stylus pen, or an electromagnetic resonance pen.

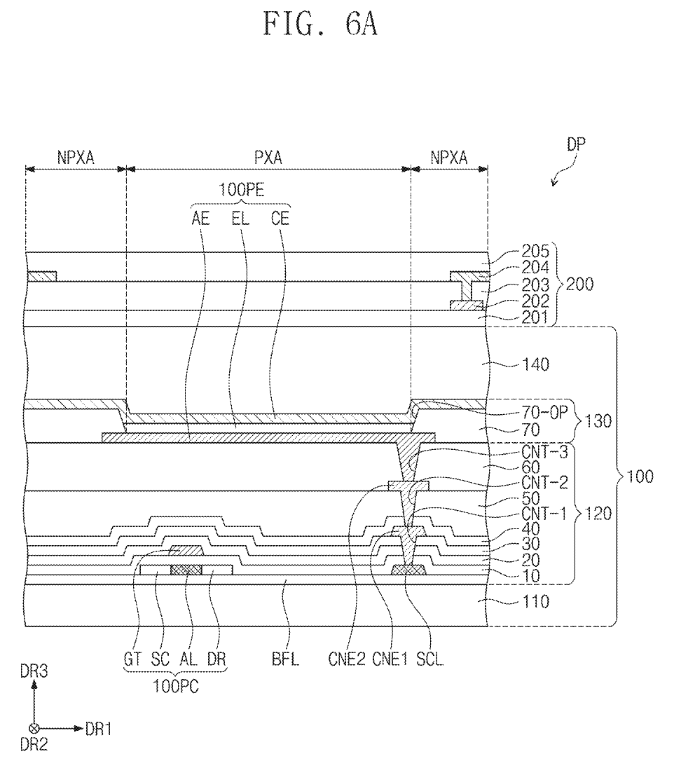

FIG. 5 is a block diagram exemplarily illustrating a use of the electronic device ED according to an embodiment.

Referring to FIG. 5, the electronic device ED may include a display layer 100, a sensor layer 200, a display driver 100C, a sensor driver 200C, a main driver 1000C, and a power circuit 1000P.

The display layer 100 may be a component that substantially generates an image. The display layer 100 may be a light-emitting display layer, and for example, the display layer 100 may be an organic light-emitting display layer, an inorganic light-emitting display layer, an organic-inorganic light-emitting display layer, a quantum dot display layer, a micro LED display layer, or a nano LED display layer.

The sensor layer 200 may be disposed on the display layer 100. The sensor layer 200 may sense an external input applied from the outside, for example, from a source external to the electronic device ED. The sensor layer 200 may be an integrated sensor continuously formed during the manufacturing process of the display layer 100, or the sensor layer 200 may be an external sensor attached to the display layer 100.

The main driver 1000C may control the overall operation of the electronic device ED. For example, the main driver 1000C may control the operation of the display driver 100C and the sensor driver 200C. The main driver 1000C may include at least one microprocessor, and the main driver 1000C may also be referred to as a host. The main driver 1000C may further include a graphic controller. The main driver 1000C may correspond to the processor 12 illustrated in FIG. 1.

The display driver 100C may drive the display layer 100. The display driver 100C may receive image data and control signals from the main driver 1000C. The control signals may include various signals. For example, the control signals may include an input vertical synchronization signal, an input horizontal synchronization signal, a main clock, a data enable signal, and the like.

The sensor driver 200C may be electrically connected to and drive the sensor layer 200. The sensor driver 200C may receive a control signal from the main driver 1000C. The control signal may include a clock signal of the sensor driver 200C.

The power circuit 1000P may include a power management integrated circuit (PMIC). The power circuit 1000P may generate a plurality of driving voltages for driving the display layer 100, the sensor layer 200, the display driver 100C, and the sensor driver 200C. For example, the plurality of driving voltages may include a gate high voltage, a gate low voltage, an ELVSS voltage, an ELVDD voltage, an initialization voltage, etc., but the disclosure is not necessarily limited to the above examples. In several embodiments, an ELVSS voltage may be a negative supply voltage or ground reference voltage, and an ELVDD voltage may be a positive supply voltage greater than the ELVSS voltage. For example the ELVSS voltage and the ELVDD voltage may be provided to the display panel DP. The power circuit 1000P may correspond to the power module 14 illustrated in FIG. 1.

In several embodiments, the electronic device ED may be implemented as a display device. For example, the display device may include a display panel DP including a display layer 100. The display device may include a sensor layer 200, a display driver 100C, a sensor driver 200C, a main driver 1000C, and a power circuit 1000P. Images IM generated by the display device may be provided to a user through the display panel DP.

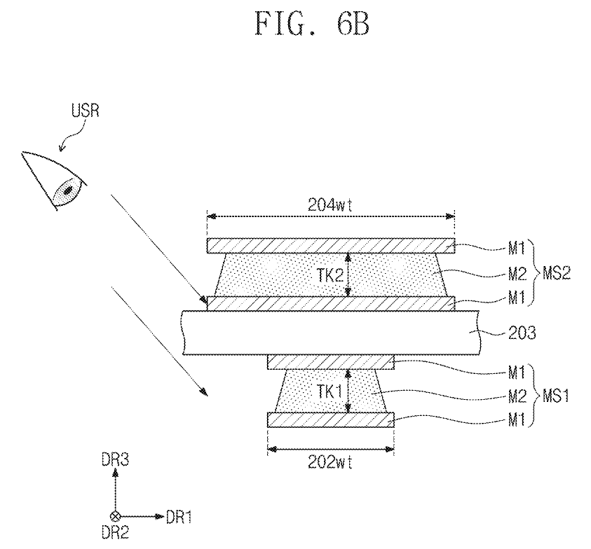

FIG. 6A is a cross-sectional view of the display panel DP according to an embodiment.

Referring to FIG. 6A, at least one buffer layer BFL is formed on the upper surface of the base layer 110. The buffer layer BFL may improve the bonding strength between the base layer 110 and a semiconductor pattern. The buffer layer BFL may be formed of a plurality of layers. Alternatively, the display layer 100 may further include a barrier layer. The buffer layer BFL may include at least one of silicon oxide, silicon nitride, or silicon oxynitride. For example, the buffer layer BFL may include a structure in which a silicon oxide layer and a silicon nitride layer are alternately stacked.

Semiconductor patterns SC, AL, DR, and SCL may be disposed on the buffer layer BFL. The semiconductor patterns SC, AL, DR, and SCL may include polysilicon. Without being necessarily limited thereto, the semiconductor patterns SC, AL, DR, and SCL may include amorphous silicon, low-temperature polycrystalline silicon, or an oxide semiconductor.

FIG. 6A illustrates only some semiconductor patterns SC, AL, DR, and SCL, and additional semiconductor patterns may be disposed in other regions. The semiconductor patterns SC, AL, DR, and SCL may be arranged in a specific order across pixels. The semiconductor patterns SC, AL, DR, and SCL may have different electrical properties depending on whether they are doped or not. The semiconductor patterns SC, AL, DR, and SCL may include high-conductivity regions SC, DR, and SCL and a low-conductivity region AL. The high-conductivity regions SC, DR, and SCL may be doped with an N-type dopant or a P-type dopant. A P-type transistor may include a doped region doped with a P-type dopant, and an N-type transistor may include a doped region doped with an N-type dopant. The low-conductivity region AL may be an undoped region or a region doped at a lower concentration than the high-conductivity regions SC, DR, and SCL.

The conductivity of the high-conductivity regions SC, DR, and SCL is greater than that of the low-conductivity region AL, and the high-conductivity regions SC, DR, and SCL may substantially serve as electrodes or signal lines. The low conductivity region AL may substantially correspond to an active region AL (or channel) of a transistor 100PC. In other words, a portion AL of the semiconductor pattern SC, AL, DR, and SCL may be the active region AL of the transistor 100PC, another portion SC or DR thereof may be a source region SC or a drain region DR of the transistor 100PC, and still another portion SCL thereof may be a connection electrode or a connection signal line SCL.

Each of the pixels may have an equivalent circuit including a plurality of transistors, at least one capacitor, and at least one light-emitting element, and the equivalent circuit diagram of a pixel may be modified into various forms. FIG. 6A exemplarily illustrates one transistor 100PC and one light-emitting element 100PE included in the pixel. However, the disclosure is not necessarily limited thereto.

The source region SC, the active region AL, and the drain region DR of the transistor 100PC may be formed from the semiconductor patterns SC, AL, DR, and SCL. The source region SC and the drain region DR may extend in opposite directions from the active region AL on a cross section. FIG. 6A illustrates a portion of the connection signal line SCL formed from the semiconductor patterns SC, AL, DR, and SCL. In several embodiments, the connection signal line SCL may be connected to the drain region DR of the transistor 100PC on a plane.

A first insulating layer 10 may be disposed on the buffer layer BFL. The first insulating layer 10 may commonly overlap a plurality of pixels and cover the semiconductor patterns SC, AL, DR, and SCL. The first insulating layer 10 may be an inorganic layer and/or an organic layer and have a single-layer or multi-layer structure. The first insulating layer 10 may include at least one of aluminum oxide, titanium oxide, silicon oxide, silicon nitride, silicon oxynitride, zirconium oxide, or hafnium oxide. In several embodiments, the first insulating layer 10 may be a single-layer silicon oxide layer. The first insulating layer 10, as well as the insulating layers of the circuit layer 120 to be described later, may be formed of an inorganic layer and/or an organic layer and have a single-layer or multi-layer structure. The inorganic layer may include at least one of the materials described above, but is not necessarily limited thereto.

A gate GT of the transistor 100PC may be disposed on the first insulating layer 10. The gate GT may be a portion of a metal pattern. The gate GT may overlap the active region AL. In a process of doping or reducing the semiconductor patterns SC, AL, DR, and SCL, the gate GT may function as a mask.

A second insulating layer 20 may be disposed on the first insulating layer 10 and cover the gate GT. The second insulating layer 20 may commonly overlap the pixels. The second insulating layer 20 may be an inorganic layer and/or an organic layer and have a single-layer or multi-layer structure. The second insulating layer 20 may include at least one of silicon oxide, silicon nitride, or silicon oxynitride. In an embodiment, the second insulating layer 20 may have a multi-layer structure including a silicon oxide layer and a silicon nitride layer.

A third insulating layer 30 may be disposed on the second insulating layer 20. The third insulating layer 30 may have a single-layer or multi-layer structure. For example, the third insulating layer 30 may have a multi-layer structure including a silicon oxide layer and a silicon nitride layer.

A first connection electrode CNE1 may be disposed on the third insulating layer 30. The first connection electrode CNE1 may be connected to the connection signal line SCL through a contact hole CNT-1 passing through the first, second, and third insulating layers 10, 20, and 30.

A fourth insulating layer 40 may be disposed on the third insulating layer 30. The fourth insulating layer 40 may be a single-layer silicon oxide layer. A fifth insulating layer 50 may be disposed on the fourth insulating layer 40. The fifth insulating layer 50 may be an organic layer.

A second connection electrode CNE2 may be disposed on the fifth insulating layer 50. The second connection electrode CNE2 may be connected to the first connection electrode CNE1 through a contact hole CNT-2 passing through the fourth insulating layer 40 and the fifth insulating layer 50.

A sixth insulating layer 60 may be disposed on the fifth insulating layer 50 and cover the second connection electrode CNE2. The sixth insulating layer 60 may be an organic layer.

The light-emitting element layer 130 may be disposed on the circuit layer 120. The light-emitting element layer 130 may include a light-emitting element 100PE. For example, the light-emitting element layer 130 may include an organic light-emitting material, an inorganic light-emitting material, an organic-inorganic light-emitting material, a quantum dot, a quantum rod, a micro LED, or a nano LED. Hereinafter, the light-emitting element 100PE is described as an organic light-emitting element, but is not necessarily limited thereto.

The light-emitting element 100PE may include a first electrode AE, a light-emitting layer EL, and a second electrode CE. The light-emitting element 100PE may be disposed in the display region 100A (see FIG. 5). The first electrode AE may be referred to as a pixel electrode, and the second electrode CE may be referred to as a common electrode.

The first electrode AE may be disposed on the sixth insulating layer 60. The first electrode AE may be connected to the second connection electrode CNE2 through a contact hole CNT-3 passing through the sixth insulating layer 60.

A pixel defining film 70 may be disposed on the sixth insulating layer 60 and cover a portion of the first electrode AE. An opening 70-OP may be defined in the pixel defining film 70. The opening 70-OP of the pixel defining film 70 may expose at least a portion of the first electrode AE.

The display region 100A (see FIG. 5) may include a light-emitting region PXA and a non-light-emitting region NPXA adjacent to the light-emitting region PXA. The non-light-emitting region NPXA may surround the light-emitting region PXA. In an embodiment, the light-emitting region PXA is defined to correspond to a partial region of the first electrode AE exposed by the opening 70-OP.

The light-emitting layer EL may be disposed on the first electrode AE. The light-emitting layer EL may be disposed in a region corresponding to the opening 70-OP. FIG. 6A exemplarily illustrates that the light-emitting layer EL is disposed in the opening 70-OP, but the embodiments of the inventive concept are not necessarily limited thereto. For example, the light-emitting layer EL may extend to cover the side surface of the pixel defining film 70 and a portion of the upper surface of the pixel defining film 70 that define the opening 70-OP.

In an embodiment, the light-emitting layer EL may be separately included in each of the pixels. When the light-emitting layer EL is separately formed in each of the pixels, each of the light-emitting layers EL may emit light of at least one color among blue, red, and green. Without being necessarily limited thereto, the light-emitting layer EL may be formed integrally and may be commonly included in a plurality of pixels. In an embodiment, the light-emitting layer EL may provide blue light or white light.

The second electrode CE may be disposed on the light-emitting layer EL. The second electrode CE may be formed integrally and may be commonly included in a plurality of pixels.

In an embodiment, a hole control layer may be disposed between the first electrode AE and the light-emitting layer EL. The hole control layer may be commonly disposed in the light-emitting region PXA and the non-light-emitting region NPXA. The hole control layer may include a hole transport layer and may further include a hole injection layer. An electron control layer may be disposed between the light-emitting layer EL and the second electrode CE. The electron control layer may include an electron transport layer and may further include an electron injection layer. The hole control layer and the electron control layer may be commonly formed in a plurality of pixels by using an open mask or an inkjet process.

The encapsulation layer 140 may be disposed on the light-emitting element layer 130. The encapsulation layer 140 may include an inorganic layer, an organic layer, and an inorganic layer that are sequentially stacked, but the layers constituting the encapsulation layer 140 are not necessarily limited thereto. The inorganic layers may protect the light-emitting element layer 130 from moisture and oxygen, and the organic layer may protect the light-emitting element layer 130 from foreign substances such as dust particles. The inorganic layers may include a silicon nitride layer, a silicon oxynitride layer, a silicon oxide layer, a titanium oxide layer, an aluminum oxide layer, or the like. The organic layer may include an acrylic-based organic layer, but the disclosure is not necessarily limited thereto.

The sensor layer 200 may include a base layer 201, a first conductive layer 202, an intermediate insulating layer 203, a second conductive layer 204, and a cover insulating layer 205.

The base layer 201 may be an inorganic layer including at least any one of silicon nitride, silicon oxynitride, or silicon oxide. Alternatively, the base layer 201 may be an organic layer including an epoxy resin, an acrylic resin, or an imide-based resin. The base layer 201 may have a single-layer structure or a multi-layer structure in which layers are stacked along the third direction DR3. In an embodiment, the sensor layer 200 may not include the base layer 201.

Each of the first conductive layer 202 and the second conductive layer 204 may have a single-layer structure or a multi-layer structure in which layers are stacked along the third direction DR3.

Each of the first conductive layer 202 and the second conductive layer 204 having a single-layer structure may include a metal layer or a transparent conductive layer. The metal layer may include molybdenum, silver, titanium, copper, aluminum, or an alloy thereof. The transparent conductive layer may include a transparent conductive oxide such as indium tin oxide (ITO), indium zinc oxide (IZO), zinc oxide (ZnO), or indium zinc tin oxide (IZTO). In several embodiments, the transparent conductive layer may include a conductive polymer such as poly(3,4-ethylenedioxythiophene) (PEDOT), metal nanowires, graphene, and the like.

Each of the first conductive layer 202 and the second conductive layer 204 having a multi-layer structure may include metal layers. The metal layers may have a three-layer structure of, for example, titanium/aluminum/titanium. The multi-layer conductive layer may include at least one metal layer and at least one transparent conductive layer.

In an embodiment, the thickness of the first conductive layer 202 may be greater than or equal to the thickness of the second conductive layer 204. When the thickness of the first conductive layer 202 is greater than the thickness of the second conductive layer 204, the resistance of the components (e.g., an electrode, a pattern, a bridge pattern, or the like) included in the first conductive layer 202 may be reduced. In addition, since the first conductive layer 202 is disposed below the second conductive layer 204, even though the thickness of the first conductive layer 202 is increased, the probability that components included in the first conductive layer 202 are visible due to external light reflection may be lower than the probability that components included in the second conductive layer 204 are visible.

At least any one of the intermediate insulating layer 203 or the cover insulating layer 205 may include an inorganic film. The inorganic film may include at least one of aluminum oxide, titanium oxide, silicon oxide, silicon nitride, silicon oxynitride, zirconium oxide, or hafnium oxide.

At least any one of the intermediate insulating layer 203 and the cover insulating layer 205 may include an organic film. The organic film may include at least any one of an acrylic-based resin, a methacrylic-based resin, polyisoprene, a vinyl-based resin, an epoxy-based resin, a urethane-based resin, a cellulose-based resin, a siloxane-based resin, a polyimide-based resin, a polyamide-based resin, or a perylene-based resin.

Although the sensor layer 200 has been described above, by way of an example, as including the first conductive layer 202 and the second conductive layer 204, that is, a total of two conductive layers, the embodiments of the inventive concept are not necessarily limited thereto. For example, the sensor layer 200 may include three or more conductive layers.

FIG. 6B is a cross-sectional view illustrating a partial configuration of the sensor layer 200 (see FIG. 6A) according to an embodiment.

Referring to FIGS. 6A and 6B, a second width 204wt of a second mesh line MS2 included in the second conductive layer 204 may be greater than or equal to a first width 202wt of a first mesh line MS1 included in the first conductive layer 202. When a user USR views the first mesh line MS1 and the second mesh line MS2 from a side, as the first mesh line MS1 has a smaller width than the second mesh line MS2, the probability that the first mesh line MS1 is visible to the user USR may be reduced.

Each of the first mesh line MS1 and the second mesh line MS2 may include first metal layers M1 and a second metal layer M2 disposed between the first metal layers M1. For example, a first metal layer M1 and a second metal layer M2 are disposed in an alternating pattern such that each metal layer M2 is positioned between two adjacent first metal layers M1, in the first mesh line MS1 and the second mesh line MS2. For example, the first metal layers M1 may include titanium (Ti), and the second metal layer M2 may include aluminum AL. However, this is only an example, and the embodiments of the inventive concept are not necessarily limited thereto.

In an embodiment, a first thickness TK1 of the second metal layer M2 of the first mesh line MS1 and a second thickness TK2 of the second metal layer M2 of the second mesh line MS2 may be substantially the same as each other, but the embodiments of the inventive concept are not necessarily limited thereto. For example, the first thickness TK1 may be greater than the second thickness TK2. Alternatively, the second thickness TK2 may be greater than the first thickness TK1. In an embodiment, each of the first thickness TK1 and the second thickness TK2 may be about 1000 angstroms or more, for example, about 6000 angstroms.

The electronic device ED may sense inputs applied from an external source. For example, the electronic device ED may sense a passive input by touch 2000. The touch 2000 may include all input means capable of providing a change in capacitance, such as a user's body or an input device (e.g., a pen/stylus).

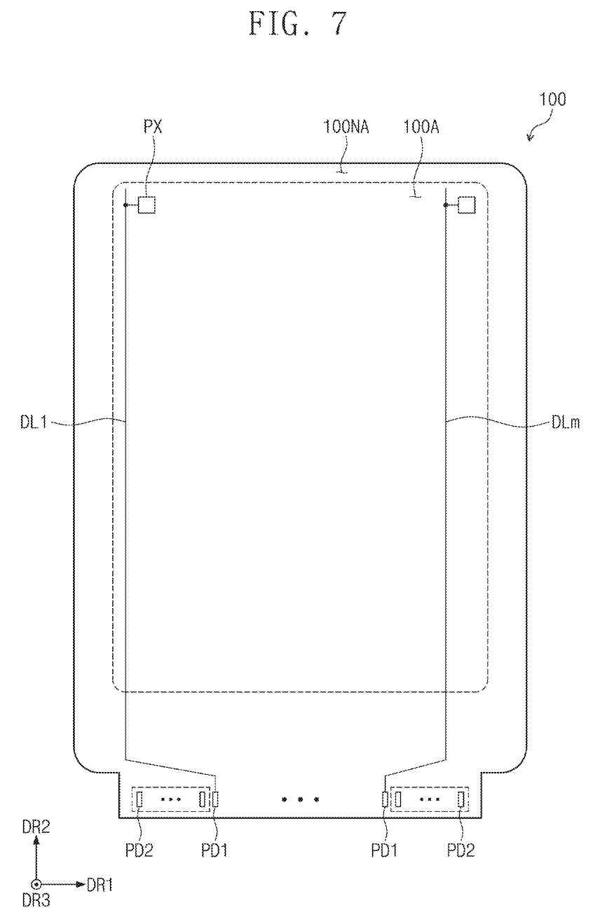

FIG. 7 is a plan view of the display layer 100 according to an embodiment of the inventive concept.

Referring to FIG. 7, a display region 100A for displaying an image and a non-display region 100NA adjacent to the display region 100A may be defined in the display layer 100. The display region 100A may correspond to the display region DA (see FIG. 2A) of the electronic device ED (see FIG. 2A), and the non-display region 100NA may correspond to the non-display region of the electronic device ED (see FIG. 2A). In this specification, an expression "one region/portion corresponds to another region/portion" means that they overlap each other and the expression is not necessarily limited to having a same area.

FIG. 7 illustrates some of the components included in the display layer 100. The display layer 100 may include a plurality of pixels PX, a plurality of lines DL1 to DLm where m is a positive integer, a plurality of first pads PD1, and a plurality of second pads PD2. The display layer 100 may further include other components in addition to those illustrated in FIG. 7.

The display region 100A and the non-display region 100NA may be distinguished based on whether the pixels PX are disposed therein. The pixels PX may be disposed in the display region 100A, the lines DL1 to DLm connected to the pixels PX may be disposed in the display region 100A and the non-display region 100NA, and the first pads PD1 and the second pads PD2 may be disposed in the non-display region 100NA. In an embodiment, a driving chip may be mounted in the non-display region 100NA. In several embodiments, a flexible circuit film on which the driving chip is mounted may be electrically connected to the first pads PD1.

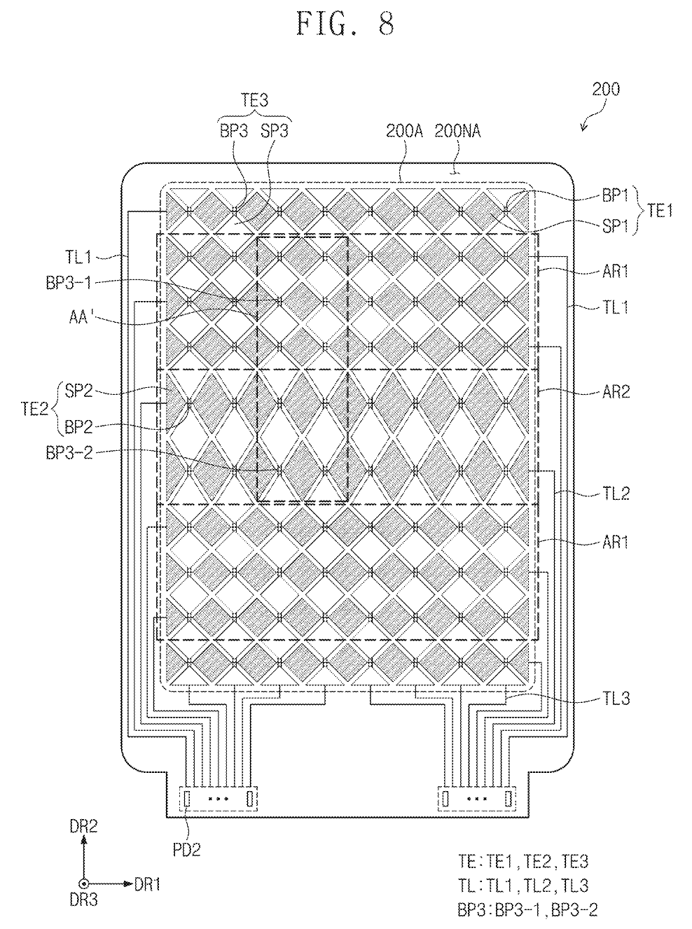

FIG. 8 is a plan view of the sensor layer 200 according to an embodiment.

Referring to FIG. 8, a sensing region 200A and a peripheral region 200NA adjacent to the sensing region 200A may be defined in the sensor layer 200. The sensing region 200A may correspond to the display region 100A of the display layer 100 (see FIG. 7), and the peripheral region 200NA may correspond to the non-display region 100NA of the display layer 100 (see FIG. 7). In an embodiment, the peripheral region 200NA may be a region in which elements or lines configured to drive a plurality of electrodes TE disposed in the sensing region 200A are disposed.

In an embodiment, a first region AR1 and a second region AR2, which is adjacent to the first region AR1, may be defined in the sensing region 200A. The first region AR1 may be provided in plurality. In an embodiment, the second region AR2 may be defined between a plurality of first regions AR1. The second region AR2 may correspond to the folding region FA illustrated in FIG. 2A, and the first regions AR1 may correspond to portions of the first non-folding region NFA1 and the second non-folding region NFA2 illustrated in FIG. 2A. For example, the second region AR2 may be folded and unfolded.

In an embodiment, the area of the first region AR1 and the area of the second region AR2 may be defined to be equal. Therefore, the area of the sensing region 200A may be larger than the sum of the areas of the two first regions AR1 and the area of the second region AR2. Hereinafter, one of the first regions AR1 will be described as a representative example.

The sensor layer 200 may include a plurality of electrodes TE. The electrodes TE may include a plurality of first electrodes TE1, a plurality of second electrodes TE2, and a plurality of third electrodes TE3.

The first electrodes TE1 may be disposed in the first region AR1. The first electrodes TE1 may extend along the first direction DR1 and be arranged in the second direction DR2 crossing the first direction DR1. The first electrodes TE1 may be disposed in a region of the sensing region 200A excluding the second region AR2. For example, in an embodiment, the first electrodes TE1 might not be disposed in the second region AR2.

The second electrodes TE2 may be disposed in the second region AR2. The second electrodes TE2 may extend along the first direction DR1 and be arranged in the second direction DR2. In an embodiment, the second electrodes TE2 may be spaced apart from the first electrodes TE1 in a direction parallel to the second direction DR2. In an embodiment, the second electrodes TE2 may be spaced apart from the first electrodes TE1 in the second direction DR2.

The third electrodes TE3 may be disposed in the first region AR1 and the second region AR2. The third electrodes TE3 may extend along the second direction DR2 and be arranged in the first direction DR1. The third electrodes TE3 may cross and be electrically insulated from the first electrodes TE1 and the second electrodes TE2.

Each of the first electrodes TE1 may include a plurality of first patterns SP1 and a plurality of first connection patterns BP1. The first connection patterns BP1 may electrically connect adjacent first patterns SP1 to each other. In an embodiment, the first connection patterns BP1 may be disposed in the same layer as the first patterns SP1 and extend from the first patterns SP1 on a plane to have an integral shape. The first patterns SP1 and the first connection patterns BP1 may be formed by being patterned from a same conductive layer through a same process. However, the embodiments of the inventive concept are not necessarily limited thereto as long as the first connection patterns BP1 electrically connect adjacent first patterns SP1 to each other in the first direction DR1.

Each of the second electrodes TE2 may include a plurality of second patterns SP2 and a plurality of second connection patterns BP2. The second connection patterns BP2 may electrically connect adjacent second patterns SP2 to each other. In an embodiment, the second connection patterns BP2 may be disposed in the same layer as the second patterns SP2 and extend from the second patterns SP2 on a plane to have an integral shape. The second patterns SP2 and the second connection patterns BP2 may be formed by being patterned from a same conductive layer by a same process. However, the embodiments of the inventive concept are not necessarily limited thereto as long as the second connection patterns BP2 electrically connect adjacent second patterns SP2 to each other in the first direction DR1.

In an embodiment, each of the third electrodes TE3 may include a plurality of sensing patterns SP3 and a plurality of bridge patterns BP3. The bridge patterns BP3 may electrically connect adjacent sensing patterns SP3 to each other. The bridge patterns BP3 may be disposed in a layer different from that of the sensing patterns SP3 and may be connected to corresponding sensing patterns SP3 through contact holes. The sensing patterns SP3 may be referred to as third patterns SP3, and the bridge patterns BP3 may be referred to as third connection patterns BP3.

The bridge patterns BP3 may include a plurality of first bridge patterns BP3-1 and a plurality of second bridge patterns BP3-2. The first bridge patterns BP3-1 may overlap the first region AR1, and the second bridge patterns BP3-2 may overlap the second region AR2. In an embodiment, the number of the first bridge patterns BP3-1 overlapping the first region AR1 may be greater than the number of the second bridge patterns BP3-2 overlapping the second region AR2. In an embodiment of the inventive concept, the number of the first bridge patterns BP3-1 may be more than or equal to about 1.5 times the number of the second bridge patterns BP3-2. For example, the number of the first bridge patterns BP3-1 overlapping the first region AR1 of the sensor layer 200 may be about 224, and the number of the second bridge patterns BP3-2 overlapping the second region AR2 of the sensor layer 200 may be about 148.

In several embodiments, a third electrode TE3 may include a plurality of first bridge patterns BP3-1 and a plurality of second bridge patterns BP3-2. For example, a number of a plurality of first bridge patterns BP3-1 overlapping the first region AR1 may be greater than a number of a plurality of second bridge patterns BP3-2 overlapping the second region AR2. In several embodiments, the disclosed arrangement of the sensor layer 200 ensures that a contact between the second bridge patterns BP3-2 and the layers disposed above and below may be reduced when the electronic device is folded and unfolded. Therefore, cracks might not form in conductive layers disposed above and below the bridge patterns. Thereby, the sensitivity and durability of the sensor layer 200 may be maintained and/or improved.

In an embodiment, the first patterns SP1, the first connection patterns BP1, the second patterns SP2, the second connection patterns BP2, and the sensing patterns SP3 may be disposed in a same layer. The bridge patterns BP3 may be disposed in a layer different from that of the sensing patterns SP3. For example, the first patterns SP1, the first connection patterns BP1, the second patterns SP2, the second connection patterns BP2, and the sensing patterns SP3 may be included in the second conductive layer 204 (see FIG. 6A), and the bridge patterns BP3 may be included in the first conductive layer 202 (see FIG. 6B).

Without being necessarily limited thereto, the first patterns SP1, the first connection patterns BP1, the second patterns SP2, the second connection patterns BP2, and the sensing patterns SP3 may be included in the first conductive layer 202 (see FIG. 6B), and the bridge patterns BP3 may be included in the second conductive layer 204 (see FIG. 6A).

According to an embodiment, the number of the second bridge patterns BP3-2 overlapping the second region AR2 may be less than the number of the first bridge patterns BP3-1 overlapping the first region AR1 that has the same area as the second region AR2. For example, the number of the second bridge patterns BP3-2 overlapping the folding region FA (see FIG. 2A) of the electronic device ED (see FIG. 2A) may be reduced compared to that in a typical case. In several embodiments, the second region AR2 may be configured to be folded and unfolded.

When the electronic device ED (see FIG. 2A) is folded and unfolded, pressure may be applied to the components disposed in the second region AR2. In an embodiment, contact may occur between the second bridge patterns BP3-2 and layers disposed above and below the second bridge patterns BP3-2, and cracks may occur in the layers disposed above and below, for example, when the electronic device ED (see FIG. 2A) is folded and unfolded. The layers disposed above and below may be, for example, the encapsulation layer 140, the base layer 201, the intermediate insulating layer 203, and the cover insulating layer 205 as illustrated in FIG. 6A, but are not necessarily limited thereto. According to an embodiment, as the number of the second bridge patterns BP3-2 overlapping the second region AR2 is reduced, the contact between the second bridge patterns BP3-2 and the layers disposed above and below due to folding and unfolding may also be reduced. Accordingly, the phenomenon of cracks occurring in the conductive layers 202 and 204 (see FIG. 6A) and the phenomenon of cracks occurring in the display panel DP (see FIG. 4) due to the second bridge patterns BP3-2 may be reduced or prevented. As a result, the reliability of the electronic device ED (see FIG. 2A) may be improved.

FIG. 8 exemplarily illustrates eight first electrodes TE1 and two second electrodes TE2, but the number of each of the first electrodes TE1 and the second electrodes TE2 is not necessarily limited thereto. For example, depending on the screen ratio or screen size of the electronic device ED (see FIG. 2A), the number of the first electrodes TE1 and the number of the second electrodes TE2 may be variously modified.

The sensor layer 200 may further include a plurality of trace lines TL. The trace lines TL may include a plurality of first trace lines TL1, a plurality of second trace lines TL2, and a plurality of third trace lines TL3.

The first trace lines TL1 may be electrically connected to the first electrodes TE1, and the second trace lines TL2 may be electrically connected to the second electrodes TE2. The third trace lines TL3 may be electrically connected to the third electrodes TE3.

As illustrated in FIG. 8, each of the first trace lines TL1 may be connected to the left or right end of the first electrodes TE1. For example, each of the first trace lines TL1 connected to the first electrodes TE1 of the odd rows among the first trace lines TL1 may be connected to the left end of a corresponding first electrode TE1. Each of the first trace lines TL1 connected to the first electrodes TE1 of the even rows among the first trace lines TL1 may be connected to the right end of a corresponding first electrode TE1. The first trace lines TL1 may extend in a direction parallel to the second direction DR2 from the left or right end of a corresponding first electrode TE1 on the peripheral region 200NA to be connected to the second pads PD2.

In an embodiment, each of the second trace lines TL2 may be connected to the left or right end of the second electrodes TE2. For example, the second trace line TL2 connected to the second electrode TE2 of an odd row among the second trace lines TL2 may be connected to the left end of a corresponding second electrode TE2. The second trace line TL2 connected to the second electrode TE2 of an even row among the second trace lines TL2 may be connected to the right end of a corresponding second electrode TE2. The second trace lines TL2 may extend from the left or right end of a corresponding second electrode TE2 on the peripheral region 200NA in a direction parallel to the second direction DR2 to be connected to the second pads PD2.

The third trace lines TL3 may be electrically connected to the lower ends of the third electrodes TE3 adjacent to the second pads PD2, respectively. The third trace lines TL3 may extend from the lower ends of corresponding third electrodes TE3 on the peripheral region 200NA to be electrically connected to the second pads PD2. Without being necessarily limited thereto, in an embodiment, the arrangement relationship of the first to third trace lines TE1, TE2, and TE3 may be variously modified.

In an embodiment, the second pads PD2 may be spaced apart from each other and electrically connected to the trace lines TL, respectively. The second pads PD2 may be electrically connected to the sensor driver 200C (see FIG. 5) that provides a driving signal. The sensor driver 200C (see FIG. 5) may apply the driving signal to the electrodes TE1, TE2, and TE3 through the second pads PD2 and the trace lines TL, or may receive a sensing signal provided from the electrodes TE1, TE2, and TE3. In several embodiments, the sensor driver 200C may be implemented as a sensor driver chip.

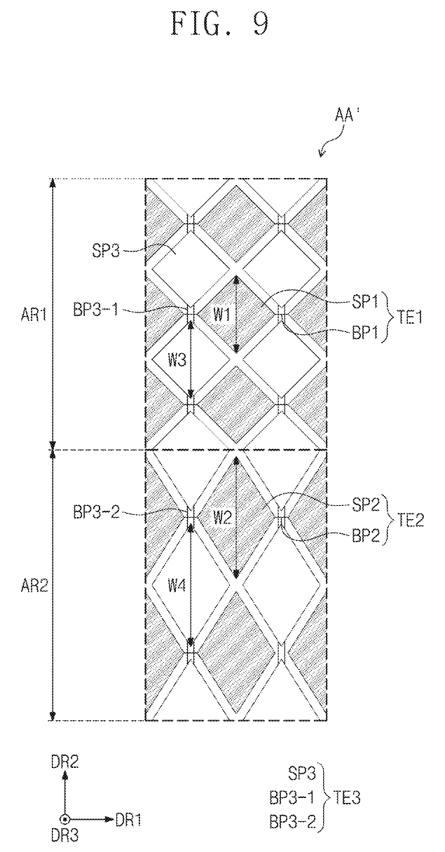

FIG. 9 is an enlarged view of region AA' of FIG. 8 according to an embodiment.

Referring to FIGS. 8 and 9, the first electrodes TE1 may be disposed in the first region AR1, and the second electrodes TE2 may be disposed in the second region AR2. The third electrodes TE3 may be disposed in the first region AR1 and the second region AR2 and may be insulated (for e.g., electrically) from and cross each of the first electrodes TE1 and the second electrodes TE2.

In an embodiment, the number of the first bridge patterns BP3-1 overlapping the first region AR1 may be greater than the number of the second bridge patterns BP3-2 overlapping the second region AR2. In an embodiment, the number of the first bridge patterns BP3-1 may be about 1.5 times the number of the second bridge patterns BP3-2.

In an embodiment, the number of the first electrodes TE1 disposed in the first region AR1 may be greater than the number of the second electrodes TE2 disposed in the second region AR2. For example, three first electrodes TE1 may be disposed in the first region AR1, and two second electrodes TE2 may be disposed in the second region AR2.

In an embodiment, a width W1 in the second direction DR2 of each of the first electrodes TE1 may be smaller than a width W2 in the second direction DR2 of each of the second electrodes TE2. In an embodiment, the width W1 of each of the first electrodes TE1 in the second direction DR2 may be less than or equal to about 2/3 of the width W2 of each of the second electrodes TE2 in the second direction DR2.

In an embodiment, a maximum width W3 in the second direction DR2 of each of the sensing patterns SP3 of the third electrode TE3 in the first region AR1 may be smaller than a maximum width W4 in the second direction DR2 of each of the sensing patterns SP3 of the third electrode TE3 in the second region AR2. In an embodiment, the maximum width W3 in the second direction DR2 of each of the sensing patterns SP3 of the third electrode TE3 in the first region AR1 may be less than or equal to about 2/3 of the maximum width W4 in the second direction DR2 of each of the sensing patterns SP3 of the third electrode TE3 in the second region AR2.

In an embodiment, the number of first bridge patterns BP3-1 overlapping one first electrode TE1 among the first bridge patterns BP3-1 on a plane may be equal to the number of second bridge patterns BP3-2 overlapping one second electrode TE2 among the second bridge patterns BP3-2 on a plane. For example, each of the number of the first bridge patterns BP3-1 overlapping one first electrode TE1 among the first bridge patterns BP3-1 on a plane and the number of the second bridge patterns BP3-2 overlapping one second electrode TE2 among the second bridge patterns BP3-2 on a plane may be 2.

According to an embodiment, the number of the second bridge patterns BP3-2 overlapping the second region AR2 (that is folded and unfolded) may be less than the number of the first bridge patterns BP3-1 overlapping the first region AR1 that has the same area as the second region AR2. Accordingly, the phenomenon of cracks occurring in the conductive layers 202 and 204 (see FIG. 6A) due to folding and unfolding and the phenomenon of cracks occurring in the display panel DP (see FIG. 4) due to the second bridge patterns BP3-2 may be reduced or prevented. As a result, the reliability of the electronic device ED (see FIG. 2A) may be improved.

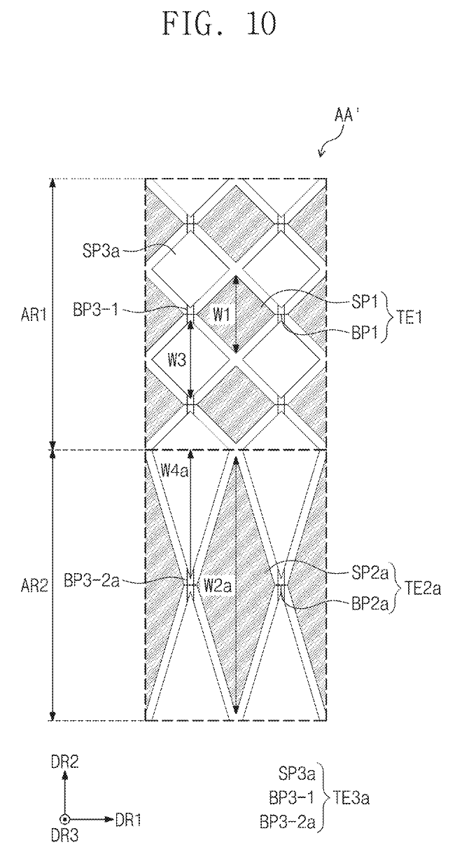

FIG. 10 is an enlarged view of region AA' of FIG. 8 according to an embodiment.

Referring to FIGS. 8 and 10, first electrodes TE1 may be disposed in the first region AR1, and second electrodes TE2a may be disposed in the second region AR2. Third electrodes TE3a may be disposed in the first region AR1 and the second region AR2 and may be insulated from and cross each of the first electrodes TE1 and the second electrode TE2a.

In an embodiment, the number of first bridge patterns BP3-1 overlapping the first region AR1 may be greater than the number of second bridge patterns BP3-2a overlapping the second region AR2. In an embodiment, the number of the first bridge patterns BP3-1 may be about three times the number of the second bridge patterns BP3-2a.

In an embodiment, the number of the first electrodes TE1 disposed in the first region AR1 may be greater than the number of the second electrodes TE2a disposed in the second region AR2. For example, three first electrodes TE1 may be disposed in the first region AR1, and one second electrode TE2 may be disposed in the second region AR2.

In an embodiment, a width W1 in the second direction DR2 of each of the first electrodes TE1 may be smaller than a width W2a in the second direction DR2 of the second electrode TE2a. In an embodiment, the width W1 in the second direction DR2 of each of the first electrodes TE1 may be less than or equal to about 1/3 of the width W2a in the second direction DR2 of the second electrode TE2a.

In an embodiment, a maximum width W3 in the second direction DR2 of each of sensing patterns SP3a of the third electrode TE3a in the first region AR1 may be smaller than a maximum width W4a in the second direction DR2 of each of the sensing patterns SP3a of the third electrode TE3a in the second region AR2.

In an embodiment, the number of first bridge patterns BP3-1 overlapping one first electrode TE1 among the first bridge patterns BP3-1 on a plane may be equal to the number of second bridge patterns BP3-2a overlapping one second electrode TE2a among the second bridge patterns BP3-2a on a plane. For example, each of the number of the first bridge patterns BP3-1 overlapping one first electrode TE1 among the first bridge patterns BP3-1 on a plane and the number of the second bridge patterns BP3-2a overlapping one second electrode TE2a among the second bridge patterns BP3-2a on a plane may be 2.

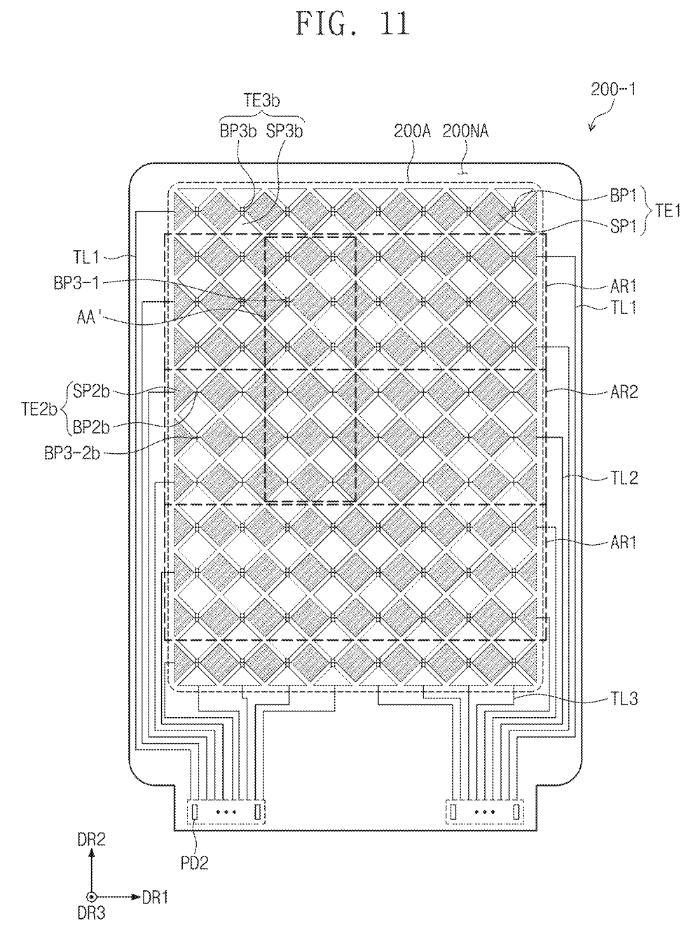

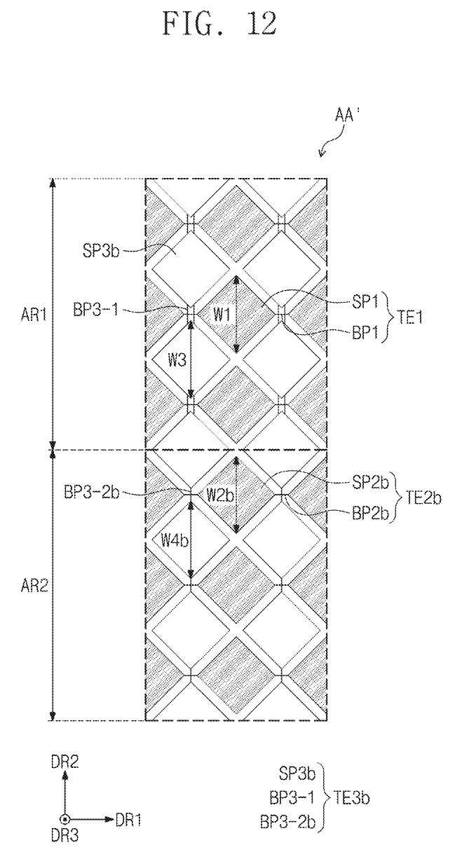

FIG. 11 is a plan view of a sensor layer 200-1 according to an embodiment. FIG. 12 is an enlarged view of region AA' of FIG. 11 according to an embodiment. In FIGS. 11 and 12, the same reference numerals are used for components identical to those in FIG. 8, and detailed descriptions thereof will be omitted. To the extent that an element is not described in detail with respect to this figure, it may be understood that the element is at least similar to a corresponding element that has been described elsewhere within the present disclosure.

In FIGS. 11 and 12, the differences from FIG. 8 will be mainly described.

Referring to FIGS. 11 and 12, first electrodes TE1 may be disposed in the first region AR1, and second electrodes TE2b may be disposed in the second region AR2. Third electrodes TE3b may be disposed in the first region AR1 and the second region AR2 and may be insulated from and cross each of the first electrodes TE1 and the second electrodes TE2b.

In an embodiment, the number of first bridge patterns BP3-1 overlapping the first region AR1 may be greater than the number of second bridge patterns BP3-2b overlapping the second region AR2. In an embodiment, the number of the first bridge patterns BP3-1 may be about twice the number of the second bridge patterns BP3-2b.

In an embodiment, the number of first electrodes TE1 disposed in the first region AR1 may be the same as the number of second electrodes TE2b disposed in the second region AR2. For example, three first electrodes TE1 may be disposed in the first region AR1, and three second electrodes TE2b may be disposed in the second region AR2.

In an embodiment, a width W1 in the second direction DR2 of each of the first electrodes TE1 may be the same as a width W2b in the second direction DR2 of each of the second electrodes TE2b. In addition, a maximum width W3 in the second direction DR2 of each of sensing patterns SP3b of the third electrode TE3b in the first region AR1 may be equal to a maximum width W4b in the second direction DR2 of each of the sensing patterns SP3b of the third electrode TE3b in the second region AR2.

In an embodiment, the number of first bridge patterns BP3-1 overlapping one first electrode TE1 among the first bridge patterns BP3-1 on a plane may be greater than the number of second bridge patterns BP3-2b overlapping one second electrode TE2b among the second bridge patterns BP3-2b on a plane. In an embodiment, the number of the first bridge patterns BP3-1 overlapping one first electrode TE1 among the first bridge patterns BP3-1 on a plane may be more than or equal to about twice the number of the second bridge patterns BP3-2b overlapping one second electrode TE2b among the second bridge patterns BP3-2b on a plane. For example, the number of the first bridge patterns BP3-1 overlapping one first electrode TE1 among the first bridge patterns BP3-1 on a plane may be two, and the number of the second bridge patterns BP3-2b overlapping one second electrode TE2b among the second bridge patterns BP3-2b on a plane may be one.

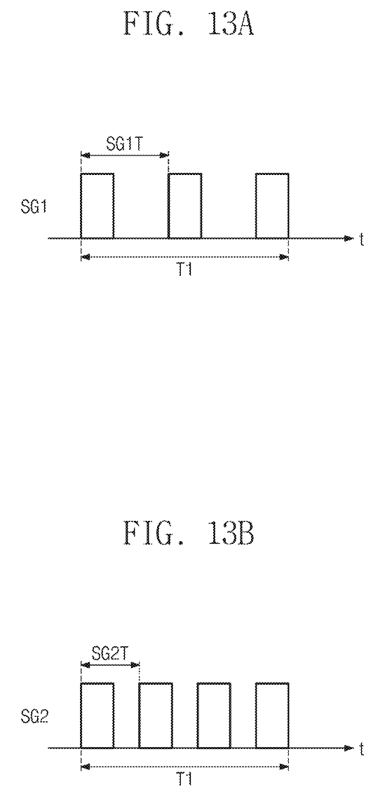

FIG. 13A illustrates a waveform of a first driving signal SG1 according to an embodiment. FIG. 13B illustrates a waveform of a second driving signal SG2 according to an embodiment.

Referring to FIGS. 5, 8, 13A, and 13B, the sensor driver 200C may apply the first driving signal SG1 and the second driving signal SG2 to the sensor layer 200.

The sensor driver 200C may apply the first driving signal SG1 to each of the first electrodes TE1 through the second pads PD2 and the first trace lines TL1. The sensor driver 200C may apply the second driving signal SG2 to each of the second electrodes TE2 through the second pads PD2 and the second trace lines TL2.

In an embodiment, the first driving signal SG1 and the second driving signal SG2 may be different from each other. That is, each of the first electrodes TE1 may receive the first driving signal SG1 from the sensor driver 200C, and each of the second electrodes TE2 may receive the second driving signal SG2 different from the first driving signal SG1 from the sensor driver 200C.

In an embodiment, a period SG1T of the first driving signal SG1 may be longer than a period SG2T of the second driving signal SG2. That is, the frequency of the first driving signal SG1 may be lower than the frequency of the second driving signal SG2. For example, based on a same time T1, the first driving signal SG1 may include about 3 periods SG1T, and the second driving signal SG2 may include about 4 periods SG2T. In an embodiment, the period SG1T of the first driving signal SG1 may be longer than the period SG2T of the second driving signal SG2, however, the disclosure is not necessarily limited thereto.

According to an embodiment, the sensor driver 200C may be configured to apply the second driving signal SG2, which has a relatively higher frequency than that of the first driving signal SG1, to each of the second electrodes TE2 disposed in the second region AR2, that may be folded and unfolded. For example, even though the number of the second bridge patterns BP3-2 overlapping the second region AR2 or the number of the second electrodes TE2 is reduced, the second driving signal SG2, which has a higher frequency than that of the first driving signal SG1 is applied to each of the second electrodes TE2 of the electronic device ED (see FIG. 2A). Therefore, the sensing sensitivity of the sensor layer 200 may be improved or maintained.

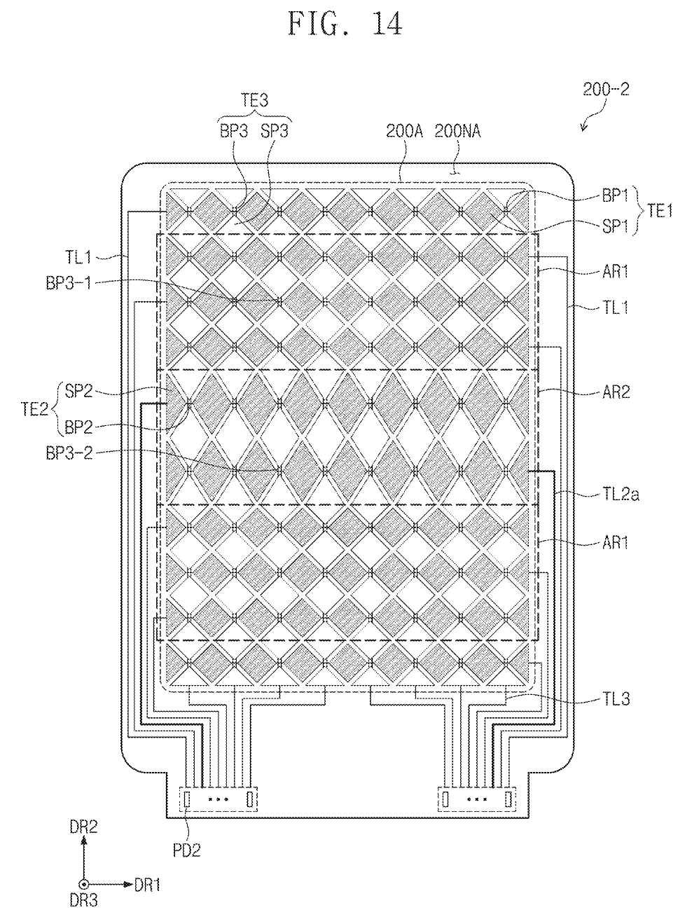

FIG. 14 is a plan view of a sensor layer 200-2 according to an embodiment of the inventive concept. In FIG. 14, the same reference numerals are used for components identical to those in FIG. 8, and detailed descriptions thereof will be omitted. In FIG. 14, the differences from FIG. 8 will be mainly described. To the extent that an element is not described in detail with respect to this figure, it may be understood that the element is at least similar to a corresponding element that has been described elsewhere within the present disclosure.

Referring to FIG. 14, the sensor layer 200-2 may further include a plurality of second trace lines TL2a.

The first trace lines TL1 may be electrically connected to the first electrodes TE1 disposed in the first region AR1, and the second trace lines TL2a may be electrically connected to the second electrodes TE2 disposed in the second region AR2.

In an embodiment, a width of each of the first trace lines TL1 may be smaller than a width of each of the second trace lines TL2a. For example, the resistance of each of the first trace lines TL1 may be greater than the resistance of each of the second trace lines TL2a.

According to an embodiment, the resistance of each of the second trace lines TL2a electrically connected to the second electrodes TE2 disposed in the second region AR2 may be smaller than the resistance of each of the first trace lines TL1 electrically connected to the first electrodes TE1 disposed in the first region AR1. For example, even though the number of the second bridge patterns BP3-2 overlapping the second region AR2 or the number of the second electrodes TE2 is reduced, the resistance of each of the second trace lines TL2a of the electronic device ED (see FIG. 2A) is smaller than the resistance of each of the first trace lines TL1. Therefore, the sensing sensitivity of the sensor layer 200-2 may be improved or maintained.

According to the above, the sensor layer may include a first electrode disposed in a first region, a second electrode disposed in a second region, which is adjacent to the first region. The second region may be configured to be folded and unfolded. A third electrode may be disposed in the first region and the second region. The third electrode may include first bridge patterns overlapping the first region and second bridge patterns overlapping the second region. The number of the second bridge patterns overlapping the second region that is folded and unfolded may be less than the number of the first bridge patterns overlapping the first region. In several embodiments, an area of the first region may be equal to the area of the second region. Accordingly, contact between the second bridge patterns and the upper and lower layers thereof may be reduced when the electronic device is folded or unfolded. Accordingly, the phenomenon of cracks occurring in conductive layers including the bridge patterns and the phenomenon of cracks occurring in layers adjacent to the conductive layers may be reduced or prevented. As a result, the reliability of the electronic device may be improved. In addition, a driving signal having a higher frequency than that of the first electrode may be applied to the second electrode, or the resistance of the trace line connected to the second electrode may be lower than the resistance of the trace line connected to the first electrode. Accordingly, the sensing sensitivity of the sensor layer may be improved or maintained.

Those skilled in the art will recognize that the present disclosure can be practiced in other specific ways without departing from its technical spirit or essential characteristics. The described embodiments should be regarded as illustrative rather than being restrictive in all aspects. Although embodiments of the present disclosure have been described with reference to the accompanying drawings, the disclosure is not necessarily limited to these embodiments and may be implemented in various forms.

What is claimed is:

1. An electronic device, comprising:
a sensor layer having a first region and a second region, the second region being adjacent to the first region, wherein the second region is configured to be folded and unfolded,
wherein the sensor layer comprises:
a first electrode disposed in the first region and extending along a first direction;
a second electrode disposed in the second region, extending along the first direction, and spaced apart from the first electrode in a second direction, wherein the second direction intersects the first direction; and
a third electrode disposed in the first region and the second region, extending along the second direction, and intersecting the first electrode and the second electrode,
wherein:
the third electrode comprises a plurality of sensing patterns and a plurality of bridge patterns, each of the plurality of bridge patterns electrically connecting adjacent sensing patterns among the plurality of sensing patterns to each other; and
an area of the first region is defined to be equal to an area of the second region,
wherein a number of a plurality of first bridge patterns among the plurality of bridge patterns overlapping the first region is greater than a number of a plurality of second bridge patterns among the plurality of bridge patterns overlapping the second region.

2. The electronic device of claim 1, wherein the number of the plurality of first bridge patterns is more than or equal to about 1.5 times the number of the plurality of second bridge patterns.

3. The electronic device of claim 1, wherein:
the first electrode and the second electrode are provided as a plurality of first electrodes and second electrodes; and
a number of the plurality of first electrodes disposed in the first region is greater than a number of the plurality of second electrodes disposed in the second region.

4. The electronic device of claim 1, wherein:
the first electrode is provided as a plurality of first electrodes;
the plurality of first electrodes are disposed in the first region; and
a single second electrode is disposed in the second region.

5. The electronic device of claim 1, wherein a number of the plurality of first bridge patterns overlapping the first electrode is equal to a number of the plurality of second bridge patterns overlapping the second electrode.

6. The electronic device of claim 5, wherein a width of the first electrode in the second direction is smaller than a width of the second electrode in the second direction.

7. The electronic device of claim 6, wherein the width of the first electrode in the second direction is less than or equal to about two-thirds of the width of the second electrode in the second direction.

8. The electronic device of claim 6, wherein a maximum width in the second direction of each of the plurality of sensing patterns of the third electrode in the first region is smaller than a maximum width in the second direction of each of the plurality of sensing patterns of the third electrode in the second region.

9. The electronic device of claim 1, wherein a number of the plurality of first bridge patterns overlapping the first electrode is greater than a number of the plurality of second bridge patterns overlapping the second electrode.

10. The electronic device of claim 9, wherein the number of the plurality of first bridge patterns overlapping the first electrode is greater than or equal to about 2 times the number of the plurality of second bridge patterns overlapping the second electrode.

11. The electronic device of claim 9, wherein a width of the first electrode in the second direction is the same as a width of the second electrode in the second direction.

12. The electronic device of claim 1, wherein:
the electronic device further comprises a sensor driver configured to drive the sensor layer;
the first electrode is configured to receive a first driving signal from the sensor driver; and
the second electrode is configured to receive a second driving signal different from the first driving signal from the sensor driver,
wherein a period of the first driving signal is longer than a period of the second driving signal.

13. The electronic device of claim 1, wherein the sensor layer further comprises:
a first trace line electrically connected to the first electrode; and
a second trace line electrically connected to the second electrode,
wherein a width of the first trace line is smaller than a width of the second trace line.

14. The electronic device of claim 1, wherein the plurality of bridge patterns are disposed in a layer different from a layer in which the plurality of sensing patterns are disposed.

15. An electronic device, comprising:
a display layer;
a sensor layer disposed on the display layer and having a first region and a second region, the second region being adjacent to the first region and configured to be folded and unfolded; and
a processor configured to control the display layer and the sensor layer,
wherein the sensor layer comprises:
a plurality of first electrodes disposed in the first region, extending along a first direction, and arranged in a second direction, wherein the second direction intersects the first direction;
a second electrode disposed in the second region and extending along the first direction; and
a plurality of third electrodes disposed in the first region and the second region, extending along the second direction, and arranged in the first direction,
wherein:
each of the plurality of third electrodes comprises a plurality of sensing patterns and a plurality of bridge patterns, each of the plurality of bridge patterns electrically connecting adjacent sensing patterns among the plurality of sensing patterns to each other, the plurality of bridge patterns including a plurality of first bridge patterns and a plurality of second bridge patterns; and
an area of the first region is defined to be equal to an area of the second region, wherein a number of the plurality of first bridge patterns overlapping the first region is greater than a number of the plurality of second bridge patterns overlapping the second region.

16. The electronic device of claim 15, wherein:
the second electrode is provided as a plurality of second electrodes; and
a number of the plurality of first electrodes disposed in the first region is greater than a number of the plurality of second electrodes disposed in the second region.

17. The electronic device of claim 15, wherein a number of the plurality of first bridge patterns overlapping a single first electrode among the plurality of first electrodes is equal to a number of the plurality of second bridge patterns overlapping the second electrode,
wherein a width of the single first electrode in the second direction is smaller than a width of the second electrode in the second direction.

18. The electronic device of claim 15, wherein a number of the plurality of first bridge patterns overlapping a single first electrode among the plurality of first electrodes is greater than a number of the plurality of second bridge patterns overlapping the second electrode,
wherein a width of the single first electrode in the second direction is equal to a width of the second electrode in the second direction.

19. The electronic device of claim 15, further comprising a sensor driver configured to drive the sensor layer,
wherein:
each of the plurality of first electrodes is configured to receive a first driving signal from the sensor driver; and
the second electrode is configured to receive a second driving signal different from the first driving signal from the sensor driver,
wherein a period of the first driving signal is longer than a period of the second driving signal.

20. A display device, comprising:
a display panel including a display layer; and
a sensor layer having a first region and a second region, the second region being adjacent to the first region, wherein the second region is configured to be folded and unfolded,
wherein the sensor layer comprises:
a first electrode disposed in the first region and extending along a first direction;
a second electrode disposed in the second region, extending along the first direction, and spaced apart from the first electrode in a second direction, wherein the second direction intersects the first direction; and
a third electrode disposed in the first region and the second region, extending along the second direction, and intersecting the first electrode and the second electrode,
wherein:
the third electrode comprises a plurality of sensing patterns and a plurality of bridge patterns, each of the plurality of bridge patterns electrically connecting adjacent sensing patterns among the plurality of sensing patterns to each other; and
an area of the first region is defined to be equal to an area of the second region,
wherein a number of a plurality of first bridge patterns among the plurality of bridge patterns overlapping the first region is greater than a number of a plurality of second bridge patterns among the plurality of bridge patterns overlapping the second region.
